(19) United States
(12) Patent Application Publication
(10) Pub. No.: US 2022/0076087 A1
(43) Pub. Date: Mar. 10, 2022

(54) IMAGE FORMING SYSTEM, IMAGE FORMING APPARATUS, AND PROGRAM

(71) Applicant: Konica Minolta, Inc., Tokyo (JP)

(72) Inventor: TAKEHIRO OGUSHI, Tokyo (JP)

(21) Appl. No.: 17/402,441

(22) Filed: Aug. 13, 2021

(30) Foreign Application Priority Data
Sep. 8, 2020 (JP) 2020-150371

(51) Int. Cl. G06K 15/00; G06K 15/16; G06K 15/02

(52) U.S. Cl. CPC G06K 15/4065; G06K 15/16; G06K 15/408; G06K 15/1809; G06K 15/403; G06K 15/002

(57) ABSTRACT

An image forming system includes: an image forming apparatus including an image former that forms an image on a recording material; a recording material supplier that supplies the recording material conveyed from a recording material storage that stores the recording material to the image former; a characteristic detector that detects a characteristic of the recording material supplied from the recording material supplier; and a hardware processor that determines, in a case where a job is interrupted, whether recording material information corresponding to a characteristic of a recording material before the interruption matches recording material information corresponding to a characteristic of a recording material after the interruption, and restarts execution of the interrupted job in a case where the recording material information corresponding to the characteristic of the recording material before the interruption matches the recording material information corresponding to the characteristic of the recording material after the interruption.

The entire disclosure of Japanese patent Application No. 2020-150371, filed on Sep. 8, 2020, is incorporated herein by reference in its entirety.

### BACKGROUND

### Technological Field

The present invention relates to an image forming system, an image forming apparatus, and a program.

### Description of the Related Art

In a recent image forming apparatus, various types of sheets are used. When the sheet type is different, the quality of an image formed on a sheet also changes, and thus, it is important for an operator not to mistake the sheet type. Normally, in a case where sheets run out during execution of a job, the execution of the job is interrupted, and the operator performs an operation of adding sheets to a sheet feed tray of the image forming apparatus. Here, it is considered that the operator who has set the sheets in the sheet feed tray before the interruption of the job can add the sheets without mistaking the sheet type.

However, in a case where the day when the job is interrupted is different from the day when the execution of the job is restarted, the sheets absorb moisture in the air if the sheets are left in the sheet feed tray. When the characteristics of the sheets change in this manner, it is necessary to adjust image forming conditions at the time of execution of the job on the next day. Therefore, the sheets are collected from the sheet feed tray on the day when the job is interrupted, and the sheets are set in the sheet feed tray again on the day when the execution of the job is restarted.

However, the operator who sets the sheets on the day when the job is interrupted may be different from the operator who sets the sheets on the day when the execution of the job is restarted. Furthermore, in recent years, various types of sheets have been used, and it is difficult to distinguish a difference between the sheet types. For this reason, the operator may set sheets of an erroneous sheet type in the sheet feed tray, and printing may be performed on the sheets of an inappropriate sheet type. In addition, even the same operator may set sheets of an erroneous sheet type in the sheet feed tray.

As a technique for preventing such sheets of an erroneous sheet type from being added, for example, a technique disclosed in JP 2012-66532 A has been proposed. JP 2012-66532 A discloses a technique in which, in a case where printing is continuously performed on a sheet when running-out of sheets or the like is resolved, the thickness of a bundle of sheets is detected again to prevent a different type of sheet from being mixed.

Incidentally, according to the technique disclosed in JP 2012-66532 A, in the case of ring binding, booklets are made for second and subsequent copies based on the bundle thickness measured for a first copy, and thus, the bundle thickness can be detected again after an interruption operation occurs. However, even if the bundle thickness is the same, it is not detected that sheet types and surface properties of the sheets are different for each sheet. For this reason, it is not possible to prevent an error that affects the image quality of an image formed on a sheet or post-processing on the sheet on which the image has been formed.

### SUMMARY

The present invention has been made in view of such a situation, and an object of the present invention is to prevent recording material information from changing before and after interruption of a job.

To achieve the abovementioned object, according to an aspect of the present invention, an image forming system reflecting one aspect of the present invention comprises: an image forming apparatus including an image former that forms an image on a recording material based on a job; a recording material supplier that supplies the recording material conveyed from a recording material storage that stores the recording material to the image former; a characteristic detector that detects a characteristic of the recording material supplied from the recording material supplier; and a hardware processor that determines, in a case where the job is interrupted, whether recording material information corresponding to a characteristic of a recording material before the interruption matches recording material information corresponding to a characteristic of a recording material after the interruption, and restarts execution of the interrupted job in a case where the recording material information corresponding to the characteristic of the recording material before the interruption matches the recording material information corresponding to the characteristic of the recording material after the interruption.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an overall configuration example of an image forming system according to an embodiment of the present invention;

FIG. 2 is a schematic diagram illustrating a configuration example of a main functional unit and hardware of each apparatus of the image forming system according to the embodiment of the present invention;

FIG. 3 is a functional block diagram illustrating an internal configuration example of an engine controller and a storage device according to the embodiment of the present invention;

FIG. 4 is a diagram illustrating configuration examples of a smoothness sensor, a basis weight sensor, and a roller home position (HP) sensor according to the embodiment of the present invention;

FIG. 5 is a diagram illustrating examples of a grain direction of a sheet according to the embodiment of the present invention;

FIG. 6 is a diagram illustrating examples in which the finish of folding and cutting differs depending on the grain direction of the sheet according to the embodiment of the present invention;

FIG. 7 is a diagram illustrating a configuration example of a charge coupled device (CCD) and a rigidity sensor for the sheet according to the embodiment of the present invention;

FIG. 8 is a flowchart illustrating an example of job interruption processing according to the embodiment of the present invention;

FIG. 9 is a flowchart illustrating an example of processing when the image forming system according to the embodiment of the present invention restarts execution of a job;

FIG. 10 is a flowchart illustrating an example of sheet specifying processing according to the embodiment of the present invention;

FIG. 11 is a flowchart illustrating an example in which a medium sensor according to the embodiment of the present invention measures a smoothness and a basis weight of the sheet;

FIG. 12 is a flowchart illustrating an example in which the medium sensor according to the embodiment of the present invention measures a sheet thickness of the sheet;

FIG. 13 is a flowchart illustrating an example of printing stop processing according to the embodiment of the present invention; and

FIG. 14 is a diagram illustrating display examples of a dialogue screen according to the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. In the present specification and the drawings, components having substantially the same function or configuration are denoted by the same reference signs, and redundant description will be omitted.

### Embodiment

<Configuration of Image Forming System>

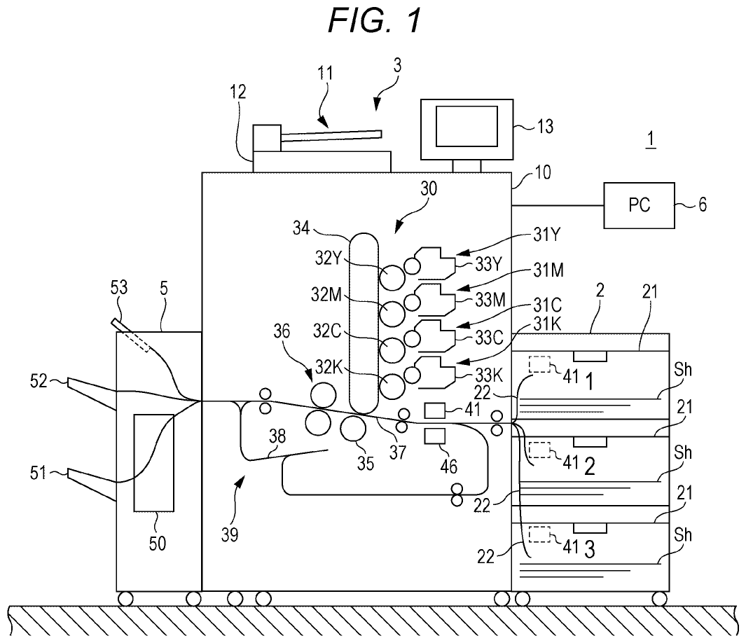

First, a configuration example of an image forming system according to the embodiment of the present invention will be described with reference to FIG. 1.

FIG. 1 is a schematic diagram illustrating an overall configuration example of an image forming system 1 according to the embodiment of the present invention. Note that FIG. 1 illustrates components considered to be necessary for the description of the present invention or related components thereof, and the image forming system of the present invention is not limited to the example illustrated in FIG. 1.

The image forming system 1 according to the present embodiment includes a sheet feeder 2, an image forming apparatus 3, and a post-processing apparatus 5.

The sheet feeder 2 (an example of a recording material supplier) includes three sheet feed trays 21, and supplies (feeds) a sheet Sh to be conveyed from one of the sheet feed trays 21 to an image former 30. The sheet feed trays 21 are containers that store sheets Sh on which image formation is performed by the image former 30. In the following description, each of the sheets Sh is also referred to as a “medium”. The sheet feed trays 21 (each of which is an example of a recording material storage) store a large number of sheets Sh having different sheet types, basis weights, or the like. As described above, the sheets set in the sheet feed trays 21 are fed to the image forming apparatus 3. In the present embodiment, an example has been described in which the three sheet feed trays 21 are provided in the sheet feeder 2, but the number of sheet feed trays 21 may be two or less, or four or more. Furthermore, the sheet Sh may be fed from one of a plurality of sheet feeders 2 to the image forming apparatus 3. As illustrated in FIG. 1, sheet feed tray numbers “1” to “3” are given so that the respective sheet feed trays 21 can be identified. Therefore, in the following description, each of the sheet feed trays 21 may be referred to as a “sheet feed tray 1”, a “sheet feed tray 2”, or the like according to the sheet feed tray number.

The image forming apparatus 3 is an example of an image forming apparatus that forms an image on a sheet by an electrophotographic method that forms an image by use of static electricity. For example, the image forming apparatus 3 forms a color image on the sheet Sh in a tandem system in which toner images of four colors of yellow (Y), magenta (M), cyan (C), and black (K) are superimposed. A personal computer (PC) 6 operated by an operator is connected to the image forming apparatus 3 via a local area network (LAN) (not illustrated). The image forming apparatus 3 performs various types of processing such as image forming processing according to a job input from the PC 6 via the LAN.

The post-processing apparatus 5 performs predetermined post-processing (also referred to as finisher processing) on the sheet Sh on which the image has been correctly formed. The sheet Sh normally subjected to the post-processing is discharged to a sheet discharge tray 51. The post-processing apparatus 5 has an online configuration in which the post-processing apparatus 5 is connected to a subsequent stage of the image forming apparatus 3, but may have an offline configuration. The post-processing apparatus 5 having the offline configuration is separated from the image forming apparatus 3. After the operator carries the sheet Sh discharged to the sheet discharge tray 51 of the image forming apparatus 3 to the post-processing apparatus 5 having the offline configuration, the post-processing apparatus 5 performs the post-processing.

The sheet Sh subjected to the post-processing by a post-processor 50 is discharged to the sheet discharge tray 51. A sheet Sh not subjected to the post-processing by the post-processor 50 is discharged to a sheet discharge tray 52. A sheet Sh having an image formation defect or a sheet Sh being conveyed at the time of interruption of the job is discharged to a sub tray 53. Since the sheets Sh in different states are discharged to the sheet discharge trays 51 and 52 and the sub tray 53, the operator can easily determine whether an abnormality has occurred in the image formation.

Here, a detailed internal configuration example of the image forming apparatus 3 will be described.

The image forming apparatus 3 includes a printing unit 10 including the image former 30 in addition to an operation display unit 13 and an image input unit 11 including an auto document feeder (ADF) 12.

The image input unit 11 optically reads an image from a document on a document table of the auto document feeder 12, performs analog-to-digital conversion on the read image, and generates image data (scan data). Note that the image input unit 11 can also read an image on a platen glass provided on an upper surface of the printing unit 10.

The operation display unit 13 includes a display unit including a liquid crystal panel or the like, and an operation unit including a touch sensor or the like. The display unit and the operation unit are integrally formed as, for example, a touch panel. The operator checks a dialogue or a screen displayed on the operation display unit 13. Here, the operation display unit 13 is used as a display that displays information for notifying the operator that an execution restart of the job has been stopped. The operation display unit 13 is also used as an inputter to which the operator inputs an instruction to interrupt or execute the job.

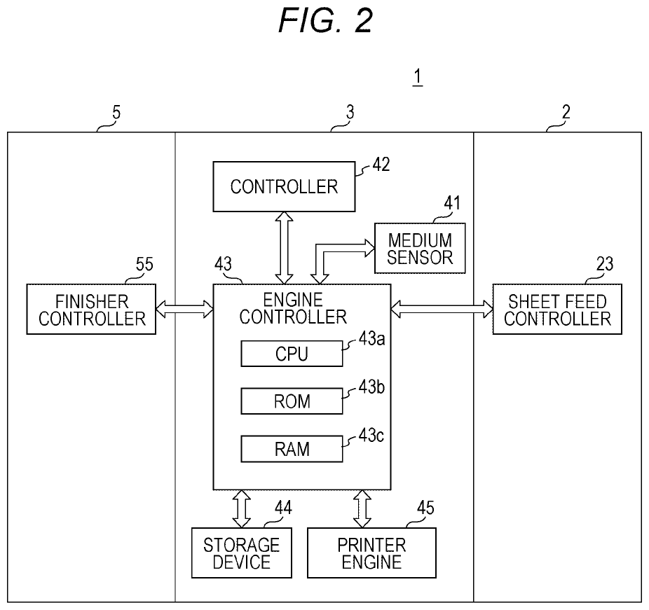

The operation display unit 13 generates an operation signal indicating contents of an operation input by the operator, and supplies the operation signal to an engine controller 43 (see FIG. 2 to be described later). In addition, the operation display unit 13 displays the contents of the operation by the operator, setting information, or the like based on a display signal supplied from the engine controller 43. Note that the operation unit may include a mouse, a tablet, or the like, and may be configured separately from the display unit.

The image forming apparatus 3 is provided with a conveyance path 37 that conveys the sheet Sh fed from the sheet feeder 2 to the post-processing apparatus 5. The conveyance path 37 is provided with a plurality of conveyance rollers for conveying the sheet Sh. In addition, a medium sensor 41 that detects a characteristic of the conveyed sheet Sh and a sheet position detection sensor 46 are provided in a portion of the conveyance path 37, which is on the upstream side of a secondary transfer unit 35. The medium sensor 41 (an example of a characteristic detector) detects the characteristic of the sheet Sh supplied from the sheet feeder 2 and conveyed on the conveyance path 37. The medium sensor 41 detects, as the characteristic of the sheet Sh, at least one of a surface property and a gloss (collectively referred to as a “smoothness”) of the sheet Sh, a basis weight of the sheet Sh, a moisture content of the sheet Sh, or an electric resistance value of the sheet Sh. Furthermore, the medium sensor 41 can also detect, as the characteristic of the sheet Sh, a grain direction and a rigidity of the sheet Sh. The sheet position detection sensor 46 detects whether the sheet Sh has reached a detection position (referred to as a “characteristic detection position”) of the medium sensor 41.

On the downstream side of a fixing unit 36, the conveyance path 37 extends and is connected to a conveyance path (not illustrated) of the post-processing apparatus 5. Furthermore, a reverse conveyance path 38 that branches off on the downstream side of the fixing unit 36 and joins the conveyance path 37 on the upstream side of the printing unit 10 is connected to the conveyance path 37. The reverse conveyance path 38 is provided with a reversing unit 39 that reverses the sheet Sh. The sheet Sh reversed by the reversing unit 39 is returned to the upstream side of the conveyance path 37 through the reverse conveyance path 38. In addition, the sheet Sh reversed by switching of the path may be returned to the conveyance path 37 on the downstream side of the fixing unit 36 and conveyed to the post-processing apparatus 5.

The image former 30 includes four image forming units 31Y, 31M, 31C, and 31K for forming toner images of respective colors of Y, M, C, and K, and forms an image on the sheet Sh based on the job. The image forming units 31Y, 31M, 31C, and 31K include charging units, exposure units (none of which is illustrated), photoconductor drums 32Y, 32M, 32C, and 32K as image carriers, and developing units 33Y, 33M, 33C, and 33K, respectively.

The developing units 33Y, 33M, 33C, and 33K irradiate respective surfaces (outer peripheral portions) of the photoconductor drums 32Y, 32M, 32C, and 32K with light corresponding to the image, thereby forming electrostatic latent images on respective peripheries of the photoconductor drums 32Y, 32M, 32C, and 32K. The developing units 33Y, 33M, 33C, and 33K then develop the toner images on the photoconductor drums 32Y, 32M, 32C, and 32K by causing toner to adhere to the electrostatic latent images.

In addition, the image former 30 includes an intermediate transfer belt 34, the secondary transfer unit 35, and the fixing unit 36. The intermediate transfer belt 34 is a belt to which the images formed on the photoconductor drums 32Y, 32M, 32C, and 32K are primarily transferred. The secondary transfer unit 35 is a roller that secondarily transfers, to the sheet Sh conveyed on the conveyance path 37, the toner images of respective colors primarily transferred to the intermediate transfer belt 34.

The fixing unit 36 is disposed on the downstream side of the secondary transfer unit 35 in a sheet conveyance direction, and performs fixing processing on the sheet Sh supplied from the image former 30, on which a color toner image has been formed. The fixing unit 36 fixes the image transferred by the image former 30 to a front side of the sheet Sh by heating and pressurizing the conveyed sheet Sh. When the image formed on the sheet is fixed in this manner, the printing is completed.

The sheet Sh on which the image has been fixed by the fixing unit 36 is conveyed to the post-processing apparatus 5 by the conveyance path 37, or is returned to the conveyance path 37 on the upstream side of the printing unit 10 after the reversing unit 39 reverses the front and back of the sheet Sh through the reverse conveyance path 38. The printing unit 10 forms an image on a back surface of the reversed sheet Sh. Thereafter, the sheet Sh subjected to the image fixing processing by the fixing unit 36 is conveyed to the post-processing apparatus 5.

The post-processor 50 of the post-processing apparatus 5 performs various types of post-processing on the sheet Sh on which the image has been formed. The post-processing includes at least one of an operation of folding the sheet Sh, an operation of binding the sheet Sh, an operation of perforating the sheet Sh, an operation of gluing the sheet Sh, or an operation of cutting the sheet Sh. The sheet Sh subjected to the post-processing as described above is discharged to the sheet discharge tray 51. Note that the sheet Sh having an image formation defect is not subjected to the post-processing and is discharged to the sub tray 53.

<Functional Configuration Example of Image Forming System>

FIG. 2 is a schematic diagram illustrating a configuration example of a main functional unit and hardware of each apparatus of the image forming system 1.

The sheet feeder 2 includes a sheet feed controller 23 that feeds sheets Sh stored in one of the sheet feed trays 21 to the image forming apparatus 3. The sheet feed controller 23 performs a sheet feeding operation under the control of the engine controller 43 included in the image forming apparatus 3. In addition, the sheet feed controller 23 transmits, to the engine controller 43, information such as the presence or absence of the sheets Sh stored in the sheet feed tray 21 or opening or closing of the sheet feed tray 21.

The image forming apparatus 3 includes the medium sensor 41, a controller 42, the engine controller 43, a storage device 44, and a printer engine 45.

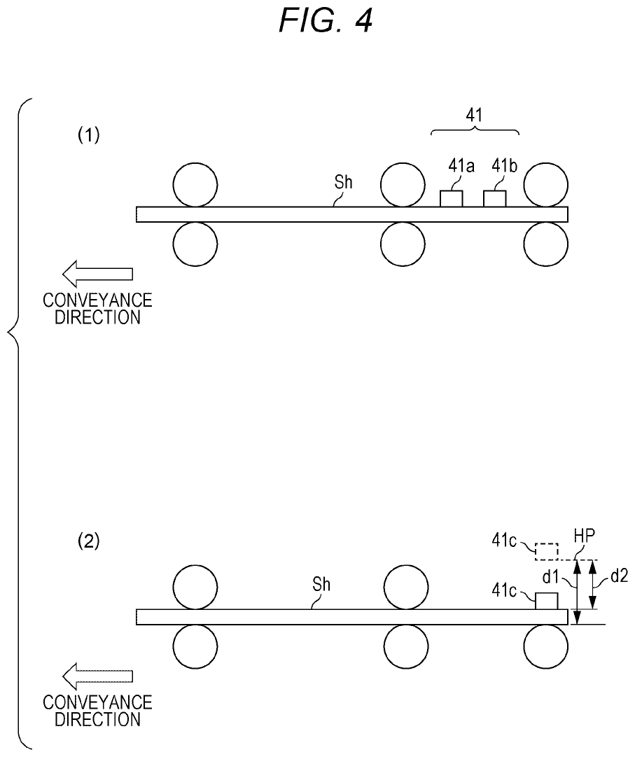

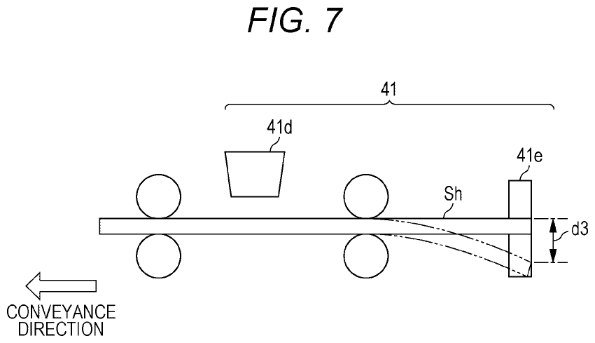

The medium sensor 41 detects the characteristic of the sheet Sh. The medium sensor 41 can detect the characteristic of the sheet Sh based on an item to which a detection instruction is input through the operation display unit 13. The characteristic of the sheet Sh includes, for example, any item of the surface property, gloss, basis weight, moisture content, or electric resistance value of the sheet Sh. Furthermore, the characteristic of the sheet Sh includes, for example, items of the rigidity and the grain direction of the sheet Sh. A configuration of the medium sensor 41 will be described with reference to FIG. 4 or FIG. 7 to be described later.

The controller 42 performs raster image processing (RIP) on the image data transferred from the PC 6 illustrated in FIG. 1. The image data subjected to the RIP is then output to the engine controller 43.

The engine controller 43 controls an operation of the printer engine 45. The engine controller 43 includes a central processing unit (CPU) 43a, a read only memory (ROM) 43b, and a random access memory (RAM) 43c. The CPU 43a, the ROM 43b, and the RAM 43c are each connected to a bus (not illustrated). The engine controller 43 communicates with the medium sensor 41, the controller 42, the storage device 44, and the printer engine 45.

The CPU 43a reads, from the ROM 43b, a program code of a control program for implementing each function according to the present embodiment, loads the program code into the RAM 43c, and executes various controls according to the present embodiment. A micro processing unit (MPU) may be used instead of the CPU 43a.

The ROM 43b stores the control program read by the CPU 43a. The ROM 43b records a program for causing the engine controller 43 to function in addition to an operating system (OS) and various parameters.

The RAM 43c is used to temporarily store data for executing the control program. Variables, parameters, and the like generated in the middle of arithmetic processing of the CPU 43a are temporarily written to the RAM 43c, and these variables, parameters, and the like are appropriately read by the CPU 43a.

The storage device 44 is an example of a nonvolatile storage, and stores various types of data output from the engine controller 43. In addition, for a job executed over a plurality of days, the storage device 44 stores the job so that the job does not disappear even if the power of the image forming apparatus 3 is turned off. As the storage device 44, for example, a hard disk drive (HDD), a solid state drive (SSD), a nonvolatile memory, or the like is used. In addition, the CPU 43a may read and execute a program stored in the storage device 44. Therefore, the storage device 44 and the ROM 43b are used as an example of a non-transitory recording medium storing a computer readable program executed by the engine controller 43.

The image data subjected to the RIP by the controller 42 is input to the printer engine 45 from the engine controller 43. The printer engine 45 controls an operation related to image formation performed by the image former 30 based on an instruction from the engine controller 43.

The post-processing apparatus 5 includes a finisher controller 55. The finisher controller 55 controls various types of post-processing (finisher processing) performed by the post-processor 50.

<Functional Configuration Example of Engine Controller and Storage Device>

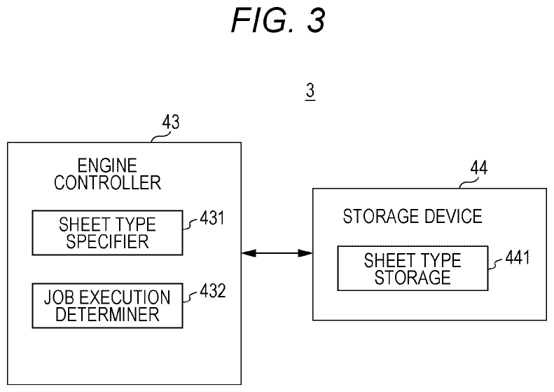

FIG. 3 is a functional block diagram illustrating an internal configuration example of the engine controller 43 and the storage device 44 of the image forming apparatus 3.

The engine controller 43 determines, in a case where the job is interrupted, whether a sheet type (recording material information) corresponding to a characteristic of a sheet Sh before the interruption matches a sheet type (recording material information) corresponding to a characteristic of a sheet Sh after the interruption, and restarts the execution of the interrupted job in a case where the sheet types match each other. Therefore, the engine controller 43 includes a sheet type specifier 431 and a job execution determiner 432. In addition, the storage device 44 includes a sheet type storage 441.

The sheet type specifier 431 (an example of a recording material information specifier) specifies the sheet type (recording material information) of the sheet Sh based on the characteristic of the sheet Sh detected by the medium sensor 41. That is, the recording material information is the type of a recording material. As the sheet type (recording material information) specified by the sheet type specifier 431, there are types corresponding to paper quality such as plain paper, high quality paper, or coated paper, a paper manufacturer, a product number, and the like. In addition, the sheet type specifier 431 can also specify a direction in which the sheets Sh are set in the sheet feed tray 21 and whether a surface of each of the set sheets Sh is a front surface or a back surface.

The job execution determiner 432 determines whether to execute or interrupt the job. The execution of the job also includes restarting the job that has been interrupted once. The job is interrupted by an instruction through the operation display unit 13 or an instruction from the sheet feed controller 23.

In a case where an instruction to interrupt the job is input through the operation display unit 13, or in a case where the sheet feeder 2 detects that the sheets Sh stored in the sheet feed tray 21 have run out, the job execution determiner 432 interrupts the execution of the job. Here, when receiving the instruction to interrupt the job in the middle of the execution of the job, the job execution determiner 432 determines to interrupt the job and causes the sheet type storage 441 to store the sheet type (recording material information) of the sheet Sh used in the job before the interruption as the recording material information corresponding to the characteristic of the recording material.

Thereafter, the job execution determiner 432 determines to restart the execution of the job when instructed to restart the execution of the job by the operator through the operation display unit 13 or on a reservation date and time when the execution of the job is restarted, which are reserved by a task scheduler. At this time, the job execution determiner 432 determines whether the sheet type (recording material information) of the sheet Sh specified by the sheet type specifier 431 based on the characteristic of the sheet Sh detected by the medium sensor 41 matches the sheet type (recording material information) of the sheet Sh read from the sheet type storage 441. The job execution determiner 432 reads the sheet type used in the job before the interruption and specified by the sheet type specifier 431 from the sheet type storage 441 that stores the sheet type. The job execution determiner 432 determines to restart the execution of the interrupted job in a case where the sheet type (recording material information) of the sheet Sh used in the job before the interruption and specified by the sheet type specifier 431 matches the sheet type (recording material information) of the sheet Sh specified by the sheet type specifier 431 in association with the restart of the execution of the interrupted job. That is, the job execution determiner 432 causes the image former 30 to form an image on the sheet Sh in the case of determining that the sheet type (recording material information) of the sheet Sh used before the interruption of the job matches the sheet type (recording material information) of the sheet Sh to be used after the restart of the job. Here, the sheet type specifier 431 may specify the sheet type in association with the restart of the execution of the job either when the above-described instruction to restart the execution of the job is made or on the reservation date and time when the execution of the job is restarted, which are reserved by the task scheduler.

On the other hand, the job execution determiner 432 determines to stop the execution of the interrupted job in a case where the sheet type (recording material information) of the sheet Sh read from the sheet type storage 441 does not match the sheet type (recording material information) of the sheet Sh specified by the sheet type specifier 431 in association with the restart of the execution of the interrupted job. That is, in the case of determining that the sheet type (recording material information) of the sheet Sh does not match the sheet type (recording material information) of the sheet Sh to be used after the restart of the job, the job execution determiner 432 causes the sheet Sh whose characteristic has been detected by the medium sensor 41 to be discharged in a state where no image is formed.

The sheet type storage 441 stores the sheet type (recording material information) of the sheet Sh used in the job before the interruption and specified by the sheet type specifier 431. The sheet type storage 441 stores the specified sheet type in association with information regarding the job executed by use of the sheet Sh. The sheet type storage 441 may also store a date and time when the job is interrupted, a cause of the interruption of the job, or the like.

<Configuration Examples of Medium Sensor>

Next, examples of various sensors used as the medium sensor 41 will be described.

FIG. 4 is a diagram illustrating configuration examples of a smoothness sensor 41a, a basis weight sensor 41b, and a roller HP sensor 41c.

An explanatory diagram (1) of FIG. 4 illustrates a configuration example of the smoothness sensor 41a and the basis weight sensor 41b.

The smoothness sensor 41a comes into contact with the surface of the sheet Sh and measures the smoothness of the sheet Sh. The smoothness measured by the smoothness sensor 41a is output to the sheet type specifier 431.

The basis weight sensor 41b measures the basis weight of the sheet Sh. The basis weight measured by the basis weight sensor 41b is also output to the sheet type specifier 431.

An explanatory diagram (2) of FIG. 4 illustrates a configuration example of the roller HP sensor 41c.

The roller HP sensor 41c is movable in a vertical direction and measures its own height. When the sheet Sh is not being conveyed, the roller HP sensor 41c indicated by a broken line in FIG. 4 is in a state of floating from the conveyance roller facing the roller HP sensor 41c. The roller HP sensor 41c measures its own height at this time as a home position. The roller HP sensor 41c measures the home position so that a distance d1 from the home position to the position where the roller HP sensor 41c is in contact with the conveyance roller facing the roller HP sensor 41c can be obtained in advance.

Next, when the sheet Sh is conveyed on the conveyance path 37, the roller HP sensor 41c moves toward the sheet Sh as indicated by a solid line in FIG. 4. The roller HP sensor 41c obtains a moving distance d2 from the home position to the position where the roller HP sensor 41c is in contact with the sheet Sh. Here, a distance obtained by subtracting the moving distance d2 from the distance d1 described above is equal to a sheet thickness of the sheet Sh. The roller HP sensor 41c then outputs the measured distance d1 to the sheet type specifier 431.

Next, the grain direction and the rigidity of the sheet Sh will be described.

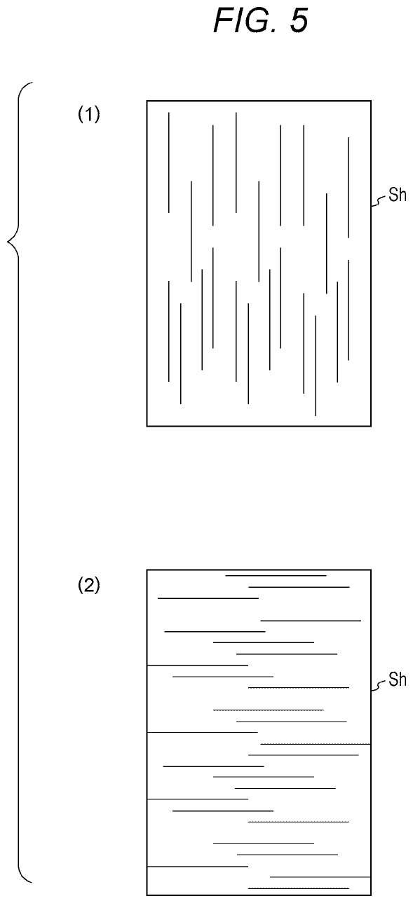

FIG. 5 is a diagram illustrating examples of the grain direction of the sheet Sh.

When a machine that makes the sheet Sh produces the sheet Sh while pulp is let to flow in a certain direction, fibers are aligned in a traveling direction of the pulp, and thus, grain of the sheet Sh is formed. Furthermore, the sheet Sh is made whose grain direction is either a long grain or a short grain depending on a cutting direction of the rolled sheet Sh.

An explanatory diagram (1) of FIG. 5 illustrates an example of a long grain sheet Sh in which the fibers flow in a parallel direction along long sides of the sheet Sh.

An explanatory diagram (2) of FIG. 5 illustrates an example of a short grain sheet Sh in which the fibers flow in a parallel direction along short sides of the sheet Sh.

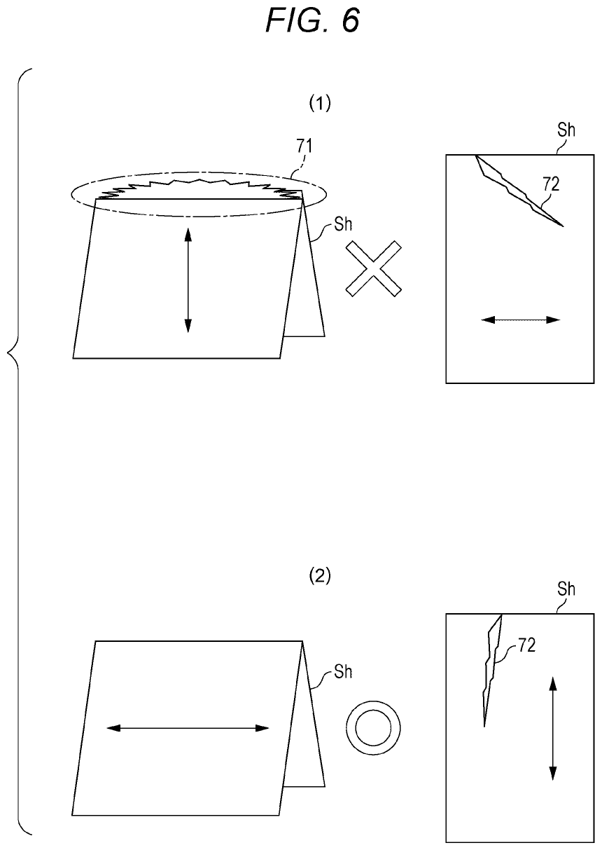

FIG. 6 is a diagram illustrating examples in which the finish of folding and cutting differs depending on the grain direction of the sheet Sh. Here, double-headed arrows in FIG. 6 each indicate the grain direction of the sheet Sh.

An explanatory diagram (1) of FIG. 6 illustrates an example in which the finish of folding and cutting of the sheet Sh is poor. For example, in a case where the grain direction of the sheet Sh is the long grain, burrs are generated in a fold line 71 and the sheet Sh is not neatly folded when the post-processor 50 folds the sheet Sh as illustrated on a left side of the explanatory diagram (1). Furthermore, in a case where the grain direction of the sheet Sh is the short grain, a tear 72 of the sheet Sh tends to be lateral or oblique as illustrated on a right side of the explanatory diagram (1). Therefore, the post-processor 50 cannot neatly cut the sheet Sh along the long grain. Note that, also in a case where the rigidity of the sheet Sh is larger than the rigidity of the sheet Sh used in the job before the interruption, the post-processor 50 cannot neatly fold or cut the sheet Sh under a post-processing condition set in the job before the interruption.

An explanatory diagram (2) of FIG. 6 illustrates an example in which the finish of folding and cutting of the sheet Sh is good. For example, in a case where the grain direction of the sheet Sh is the short grain, the post-processor 50 can neatly fold the sheet Sh along the short grain as illustrated on a left side of the explanatory diagram (2). In addition, in a case where the grain direction of the sheet Sh is the long grain, the tear 72 of the sheet Sh is likely to follow the long grain as illustrated on a right side of the explanatory diagram (2). Therefore, the post-processor 50 can neatly cut the sheet Sh along the long grain. In addition, if the rigidity of the sheet Sh is the same as the rigidity of the sheet Sh used in the job before the interruption, the post-processor 50 can neatly fold and cut the sheet Sh under the post-processing condition set in the job before the interruption.

As described above, the ease of cutting and folding varies depending on the grain direction of the sheet Sh. Therefore, in a case where post-processing including folding, binding, or cutting is set in the job, the medium sensor 41 detects the characteristic of the sheet Sh so that the grain direction and the rigidity do not change before and after the interruption of the job. In a case where contents of the post-processing do not match the characteristic of the sheet Sh, the job execution determiner 432 (see FIG. 3) prompts the operator to set, in the sheet feed tray 21, sheets Sh having a sheet characteristic that matches the contents of the post-processing. Therefore, the quality of the post-processing operation performed by the post-processor 50 is secured.

Next, a method of measuring the grain direction and the rigidity of the sheet Sh will be described.

FIG. 7 is a diagram illustrating a configuration example of a CCD 41d and a rigidity sensor 41e.

The medium sensor 41 includes the CCD 41d and the rigidity sensor 41e. The CCD 41d can analyze an image obtained by capturing an upper surface of the conveyed sheet Sh and detect the grain direction of the sheet Sh as the characteristic of the sheet Sh. Information regarding the grain direction of the sheet Sh detected by the CCD 41d is output to the sheet type specifier 431.

Furthermore, a rear end of the sheet Sh temporarily stopped at the characteristic detection position of the conveyance path 37 is lowered by its own weight. The rigidity sensor 41e measures a distance d3 by which the rear end of the sheet Sh is lowered by its own weight, and detects the rigidity of the sheet Sh based on the distance d3. The rigidity of the sheet Sh is output to the sheet type specifier 431. Note that a line sensor that detects the rear end of the sheet Sh may be mounted on the rigidity sensor 41e.

In addition, a moisture content sensor (not illustrated) that detects the moisture content of the sheet Sh or a resistance value sensor (not illustrated) that detects the electric resistance value of the sheet Sh may be used as the medium sensor 41. In this case, the moisture content detected by the moisture content sensor or the electric resistance value detected by the resistance value sensor is output to the sheet type specifier 431.

<Processing Performed by Image Forming System>

Next, examples of processing performed by the image forming system 1 will be described. Here, after job interruption processing is described, processing at the time of restarting the execution of the job will be described.

<Job Interruption Processing>

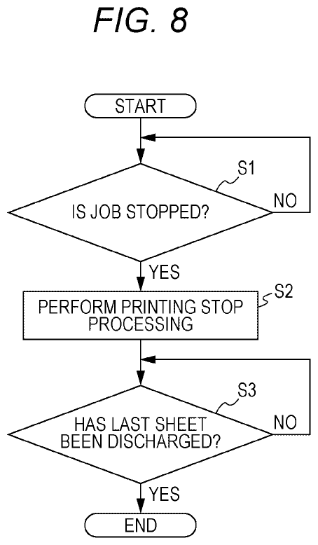

FIG. 8 is a flowchart illustrating an example of the job interruption processing.

First, the job execution determiner 432 determines whether to stop (interrupt) the job being executed (S1). For example, in a case where the operator inputs an instruction to stop the job through the operation display unit 13, or in a case where the sheet feed controller 23 detects that the sheets Sh in the sheet feed tray 21 have run out, the job being executed is stopped. If determining that it is unnecessary to stop the job being executed (NO in S1), the job execution determiner 432 continues the execution of the job. The processing then returns to step S1 again.

On the other hand, in the case of determining to stop the job being executed (YES in S1), the job execution determiner 432 performs stop processing on the printing operation (S2). In this stop processing, the operation of the image former 30 is stopped, and an operation of discharging all sheets Sh being conveyed on the conveyance path 37 to the sub tray 53 is performed.

The job execution determiner 432 then determines whether the last sheet Sh conveyed on the conveyance path 37 has been discharged (S3). If determining that the last sheet Sh has not been discharged (NO in S3), the job execution determiner 432 continues the determination in step S3 until the last sheet Sh is discharged. On the other hand, if determining that the last sheet Sh has been discharged (YES in S3), the job execution determiner 432 ends the present processing.

<Processing of Restarting Execution of Job>

Next, processing at the time of restarting the execution of the interrupted job will be described.

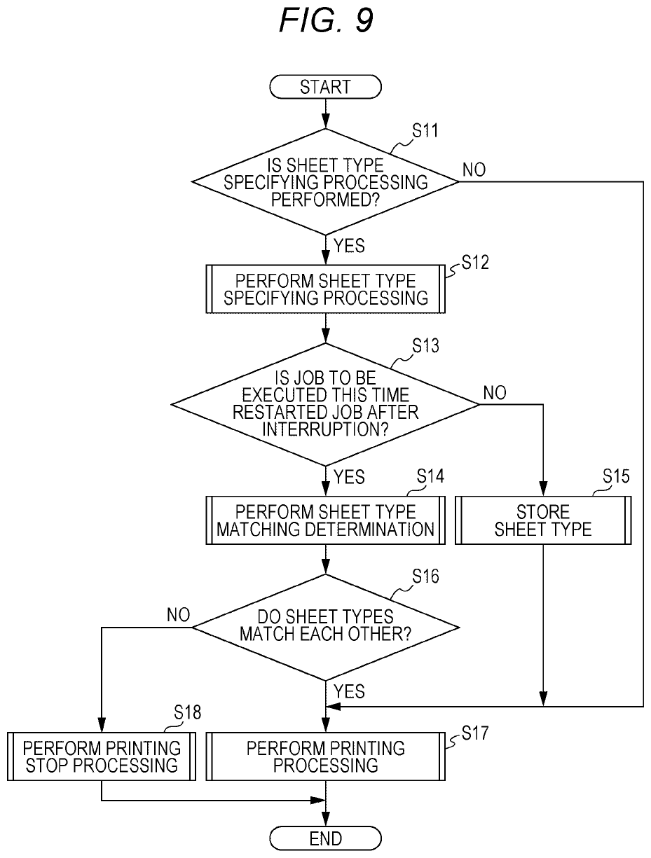

FIG. 9 is a flowchart illustrating an example of the processing when the image forming system 1 restarts the execution of the job.

First, the sheet type specifier 431 determines whether to perform sheet type specifying processing on the sheet Sh (S11). The sheet Sh on which the sheet type specifier 431 performs the sheet type specifying processing needs to be, for example, the first sheet at the start of a new job or the first sheet at the time of restarting the execution of the interrupted job. In addition, the sheet type specifying processing is also performed when the sheet Sh is changed due to the change of the sheet feed tray 21 in the middle of execution of the job. Conversely, the sheet type specifier 431 does not perform the sheet type specifying processing, for example, when there is no change in the state of the sheet feed tray 21 for a certain period after the interruption of the job. Specifically, it can be said that there is no change in the state of the sheet feed tray 21 if the sheet feed tray 21 has not been opened or closed after the interruption of the job and it is within one hour from the interruption of the job to the restart of the job.

Therefore, in the case of determining that the state of the sheet feed tray 21 that stores the sheet Sh supplied before the execution of the job is interrupted does not change at the time of determining to restart the execution of the job, the job execution determiner 432 determines to restart the execution of the job without making the matching determination on the sheet types (recording material information) of the sheets Sh. However, in a case where there are no sheets Sh in the sheet feed tray 21 or in a case where the sheet feed tray 21 is opened for replacement of the sheets Sh, the job execution determiner 432 determines whether to restart the execution of the job based on a result of the sheet type specifying processing by the sheet type specifier 431.

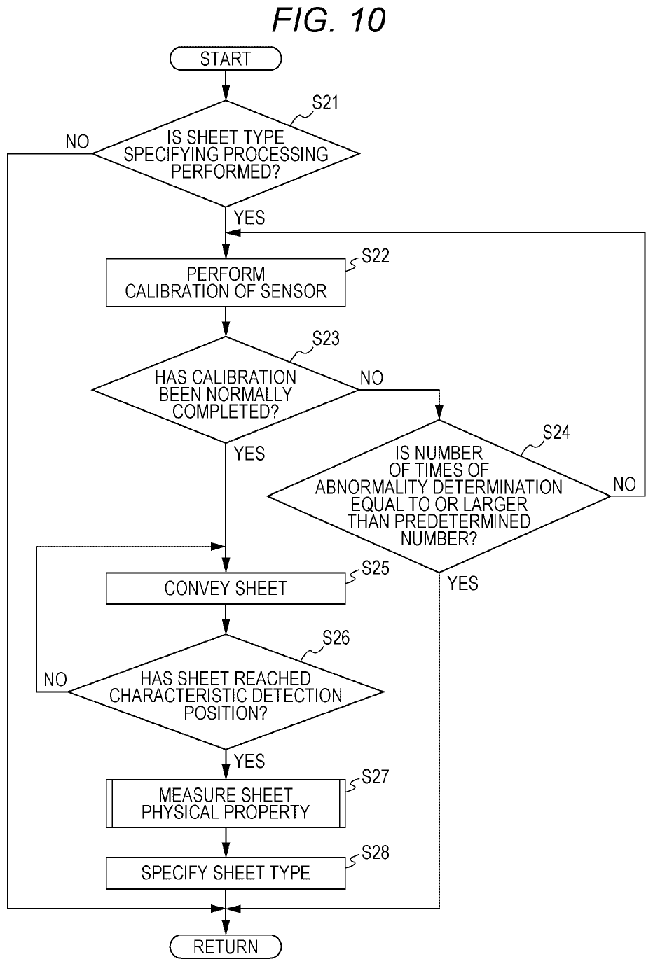

Next, the sheet type specifier 431 performs the sheet type specifying processing for specifying the sheet type of the sheet Sh (S12). In the sheet type specifying processing, the job execution determiner 432 causes the medium sensor 41 to detect the characteristic of the sheet Sh on which no image has been formed by the image former 30, and causes the sheet type specifier 431 to specify the sheet type (recording material information) of the sheet Sh. Details of the sheet type specifying processing will be described below with reference to FIGS. 10 to 12.

After the sheet type of the sheet Sh is specified in step S12, the job execution determiner 432 determines whether the job to be executed this time is a restarted job after interruption (S13). The interrupted job is, for example, either a job executed last time but stopped without being completed or a job whose interruption time has exceeded one hour since an interruption button was pressed through the operation display unit 13.

In the case of determining that the job to be executed this time is the restarted job after interruption (YES in S13), the job execution determiner 432 performs sheet type matching determination (S14). The sheet type matching determination is processing of determining whether the sheet type of the sheet Sh used in the job executed before the interruption matches the sheet type of the sheet Sh to be used in the job to be restarted.

In the case of determining in step S13 that the job to be executed this time is not the restarted job after interruption (NO in S13), the job execution determiner 432 causes the sheet type storage 441 to store the sheet type of the sheet Sh to be used in the job to be executed this time (S15).

After step S14, the job execution determiner 432 determines whether the sheet types match each other (S16). In the case of determining that the sheet types match each other (YES in S16), or in a case where the sheet type of the sheet Sh to be used in the job to be executed this time is stored in the sheet type storage 441 (S15), the job execution determiner 432 executes the printing processing (S17), and ends the present processing.

On the other hand, in the case of determining that the sheet types do not match each other (NO in S16), the job execution determiner 432 executes the printing stop processing (S18). In this processing, the job execution determiner 432 stops the operation of the image former 30, and ends the present processing.

<Example of Sheet Specifying Processing>

Here, the sheet specifying processing in step S12 in FIG. 9 will be described.

FIG. 10 is a flowchart illustrating an example of the sheet specifying processing.

First, the sheet type specifier 431 determines whether to specify the sheet type (S21). In a case where the sheet type specifier 431 determines not to specify the sheet type (NO in S21), the sheet type specifier 431 ends the present processing without specifying the sheet type, and returns the processing to step S13 in FIG. 10.

On the other hand, in the case of determining to specify the sheet type (YES in S21), the sheet type specifier 431 executes calibration of the medium sensor 41 (S22). In this calibration, for example, processing is performed in which a read value acquired in a dark place by the CCD 41d (see FIG. 7) of the medium sensor 41 is calibrated to zero.

Next, the sheet type specifier 431 determines whether the calibration in step S22 has been normally completed (S23). In the case of determining that the calibration has not been normally completed (NO in S23), the sheet type specifier 431 determines whether the number of times of abnormality determination in step S23 is equal to or larger than a predetermined number (S24).

If the number of times of abnormality determination in step S23 is smaller than the predetermined number (NO in S24), the sheet type specifier 431 returns the processing to step S22 and performs the calibration again. On the other hand, if the number of times of abnormality determination in step S23 is equal to or larger than the predetermined number (YES in S24), the sheet type specifier 431 ends the present processing without specifying the sheet type, and returns the processing to step S13 in FIG. 10.

In the case of determining in step S23 that the calibration has been normally completed (YES in S23), the sheet type specifier 431 causes the sheet Sh to be conveyed from the sheet feed tray 21 to the image forming apparatus 3 (S25).

Next, the sheet type specifier 431 determines whether the sheet Sh conveyed by the conveyance path 37 has reached the characteristic detection position based on a detection value of the sheet position detection sensor 46 illustrated in FIG. 1 (S26). In the case of determining that the sheet Sh has not reached the characteristic detection position (NO in S26), the sheet type specifier 431 returns the processing to step S25 and continues the conveyance of the sheet Sh by the conveyance path 37.

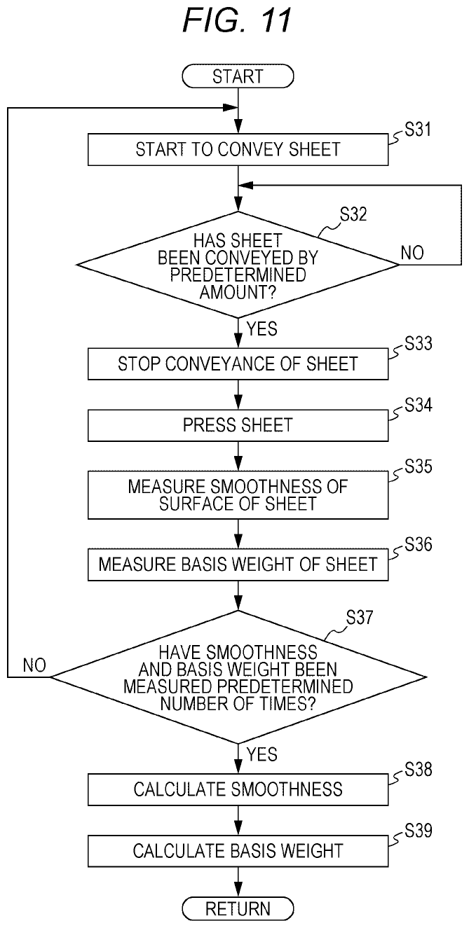

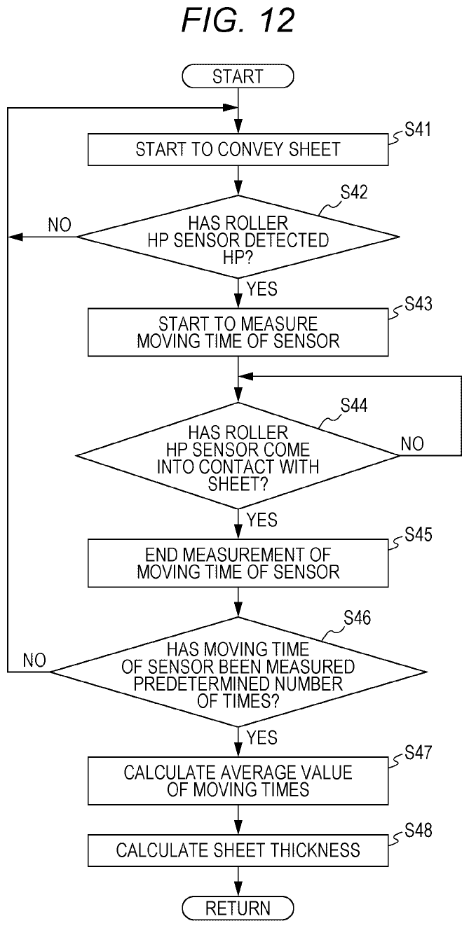

On the other hand, in the case of determining that the sheet Sh has reached the characteristic detection position (YES in S26), the sheet type specifier 431 measures a sheet physical property, which is illustrated in FIG. 11 or 12 to be described later (S27). The sheet type specifier 431 then specifies the sheet type of the sheet Sh based on the sheet physical property measured in step S27 (S28), and returns the processing to step S13 in FIG. 10.

Here, the processing in step S27 will be described with reference to FIGS. 11 and 12. Note that processing of a flowchart in FIG. 11 or 12 is executed depending on the type of the medium sensor 41.

<Calculation Processing of Smoothness and Basis Weight>

FIG. 11 is a flowchart illustrating an example in which the medium sensor 41 measures the smoothness and the basis weight of the sheet Sh. FIG. 11 illustrates processing in a case where the smoothness sensor 41a and the basis weight sensor 41b are used as the medium sensor 41.

The sheet type specifier 431 starts to convey the sheet Sh determined to have reached the characteristic detection position in step S26 in FIG. 10 (S31). In the present processing, since the sheet Sh that has reached the characteristic detection position is moved several times to measure a plurality of smoothnesses and basis weights, the sheet Sh is conveyed in step S31.

Next, the sheet type specifier 431 determines whether the sheet Sh has been conveyed by a predetermined amount by the conveyance path 37 (S32). In the case of determining that the sheet Sh has not been conveyed by the predetermined amount (NO in S32), the sheet type specifier 431 continues the processing in step S32 until the sheet Sh is conveyed by the predetermined amount.

In the case of determining that the sheet Sh has been conveyed by the predetermined amount (YES in S32), the sheet type specifier 431 causes the conveyance path 37 to stop the conveyance of the sheet Sh (S33). The sheet type specifier 431 then causes the smoothness sensor 41a and the basis weight sensor 41b to press the sheet Sh (S34).

The sheet type specifier 431 then causes the smoothness sensor 41a to measure the smoothness of the surface of the sheet Sh (S35), and further causes the basis weight sensor 41b to measure the basis weight of the sheet Sh (S36). The smoothness and the basis weight measured by the sensors are stored in the RAM 43c (see FIG. 2) for each measurement.

Next, the sheet type specifier 431 determines whether the smoothness and the basis weight have been measured a predetermined number of times (S37). If the smoothness and the basis weight have not been measured the predetermined number of times (NO in S37), the sheet type specifier 431 continues the processing in steps S31 to S36 again.

On the other hand, if the smoothness and the basis weight have been measured the predetermined number of times (YES in S37), the sheet type specifier 431 sets, as the smoothness of the sheet Sh, an average value of the smoothnesses calculated by reading the smoothnesses for the predetermined number of times from the RAM 43c (S38). Similarly, the sheet type specifier 431 sets, as the basis weight of the sheet Sh, an average value of the basis weights calculated by reading the basis weights for the predetermined number of times from the RAM 43c (S39). Thereafter, the sheet type specifier 431 returns the processing to step S28 in FIG. 10.

<Sheet Thickness Calculation Processing>

FIG. 12 is a flowchart illustrating an example in which the medium sensor 41 measures the sheet thickness of the sheet Sh. FIG. 12 illustrates an example of processing in a case where the roller HP sensor 41c is used as the medium sensor 41.

The sheet type specifier 431 starts to convey the sheet Sh determined to have reached the characteristic detection position in step S26 in FIG. 10 (S41). In the present processing, since the sheet Sh that has reached the characteristic detection position is moved several times to obtain a plurality of distances d1 (see FIG. 4), the sheet Sh is conveyed in step S41.

Next, the sheet type specifier 431 determines whether the roller HP sensor 41c has detected a home position of a conveyance roller 60 (S42). In the case of determining that the roller HP sensor 41c has not detected the home position (NO in S42), the sheet type specifier 431 repeats the processing in step S41 until the roller HP sensor 41c detects the home position.

On the other hand, in the case of determining that the roller HP sensor 41c has detected the home position of the conveyance roller 60 (YES in S42), the sheet type specifier 431 starts to move the roller HP sensor 41c from the home position toward the sheet Sh. Here, the sheet type specifier 431 starts to measure a moving time of the roller HP sensor 41c (S43).

Next, the sheet type specifier 431 determines whether the roller HP sensor 41c has come into contact with the sheet Sh (S44). If the sheet type specifier 431 does not detect that the roller HP sensor 41c has come into contact with the sheet Sh (NO in S44), the sheet type specifier continues to move the roller HP sensor 41c toward the sheet Sh.

On the other hand, if detecting that the roller HP sensor 41c has come into contact with the sheet Sh (YES in S44), the sheet type specifier 431 ends the measurement of the moving time of the roller HP sensor 41c (S45). The moving time of the roller HP sensor 41c measured by the roller HP sensor 41c is stored in the RAM 43c for each measurement.

Next, the sheet type specifier 431 determines whether the moving time of the roller HP sensor 41c has been measured a predetermined number of times (S46). If the moving time has not been measured the predetermined number of times (NO in S46), the sheet type specifier 431 continues the processing in steps S42 to S45 again.

On the other hand, if the moving time has been measured the predetermined number of times (YES in S46), the sheet type specifier 431 reads the moving times for the predetermined number of times from the RAM 43c to calculate an average value of the moving times (S47). The sheet type specifier 431 then multiplies the average value of the moving times by a moving speed of the roller HP sensor 41c to calculate a moving distance of the roller HP sensor 41c (for example, the moving distance d2 illustrated in FIG. 4). Furthermore, the sheet type specifier 431 calculates the sheet thickness of the sheet Sh by subtracting the moving distance of the roller HP sensor 41c from the maximum distance in which the roller HP sensor 41c can move (for example, the distance d1 illustrated in FIG. 4) (S48). Thereafter, the sheet type specifier 431 returns the processing to step S28 in FIG. 10.

Note that, in a case where the post-processing is set for the job, the job execution determiner 432 can determine whether to restart the execution of the job based on the grain direction and the rigidity of the sheet Sh detected by the medium sensor 41, although the processing is not illustrated in the flowchart. For example, if the grain direction of the sheet Sh used in the job before the interruption is different from the grain direction of the sheet Sh to be used in the job to be restarted, the job execution determiner 432 determines not to restart the execution of the job. In addition, if the rigidity of the sheet Sh used in the job before the interruption is different from the rigidity of the sheet Sh to be used in the job to be restarted, the job execution determiner 432 determines not to restart the execution of the job. On the other hand, if the grain direction and the rigidity of the sheet Sh before the interruption of the job match those of the sheet Sh after the interruption of the job, the job execution determiner 432 can determine to restart the execution of the job.

<Example of Printing Stop Processing>

Here, the printing stop processing in step S18 in FIG. 9 will be described.

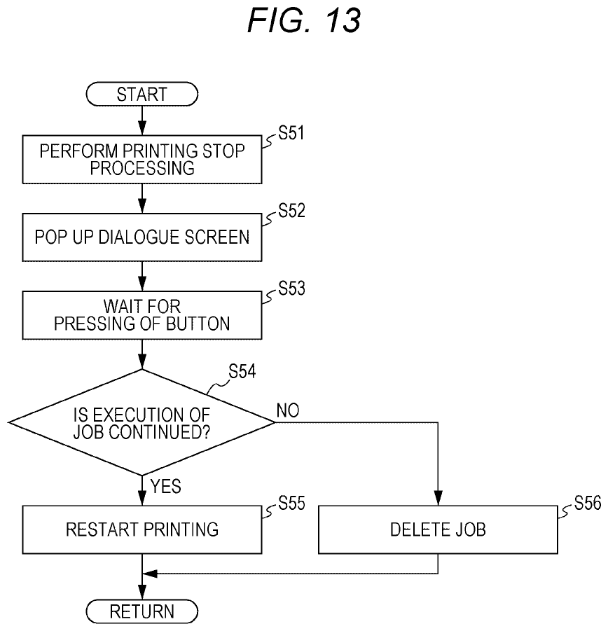

FIG. 13 is a flowchart illustrating an example of the printing stop processing.

First, the job execution determiner 432 starts the printing stop processing (S51). Here, if the image forming apparatus 3 is a mechanism capable of stopping the printing before forming an image on the sheet Sh, the job execution determiner 432 can leave the sheet Sh on the conveyance path 37 and perform the printing using the sheet Sh left on the conveyance path 37 after the restart of the job. On the other hand, if the image forming apparatus 3 is a mechanism that cannot stop the printing before forming an image on the sheet Sh, the job execution determiner 432 discharges, as a waste sheet, the sheet Sh being conveyed on the conveyance path 37 to the sub tray 53.

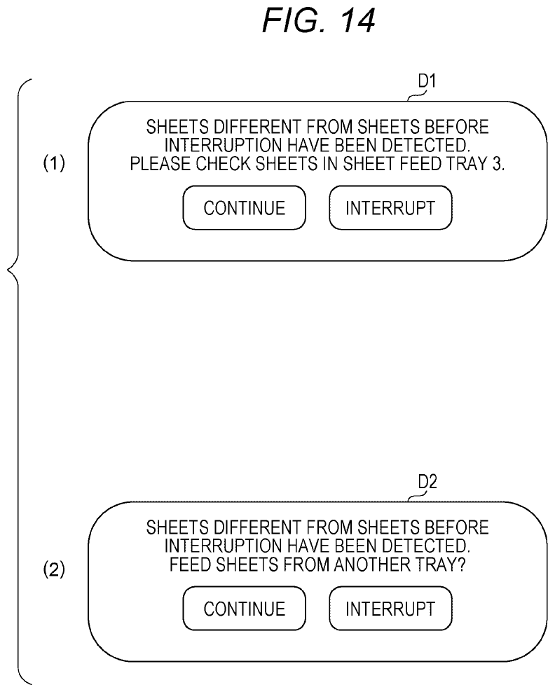

Next, the job execution determiner 432 pops up a dialogue screen D1 or D2 illustrated in FIG. 14 to be described later on the operation display unit 13 (S52). The dialogue screen D1 or D2 is displayed in a case where it is determined that the sheet type of the sheet Sh used in the job before the interruption does not match that of the sheet Sh to be used in the job after the restart in the sheet type matching determination performed in step S16 in FIG. 9 after the restart of the job. Display examples of the dialogue screen D1 or D2 will be described below with reference to FIG. 14.

Next, the job execution determiner 432 waits for pressing of a button for giving an instruction to continue or interrupt the execution of the job, which is shown in the dialogue screen D1 or D2 (S53). When the button is pressed, the job execution determiner 432 determines whether the button for continuing the execution of the job has been pressed (S54).

If determining that the button for continuing the execution of the job has been pressed (YES in S54), the job execution determiner 432 restarts the execution of the job and restarts the image forming processing (printing) by the image former 30 (S55). On the other hand, if determining that the button for continuing the execution of the job has not been pressed (NO in S54), that is, if determining that the button for giving an instruction to interrupt the execution of the job has been pressed, the job execution determiner 432 deletes the job scheduled to be restarted (S56). After steps S55 and S56, the processing ends.

<Display Examples of Dialogue Screen>

FIG. 14 is a diagram illustrating the display examples of the dialogue screen D1 or D2.

When the job execution determiner 432 determines to stop the execution of the interrupted job, information for notifying the operator that the processing of forming an image on the sheet Sh has been stopped is displayed on the dialogue screen D1 or D2 popped up on the operation display unit 13. Here, a message prompting the operator to check the sheets Sh stored in the sheet feed tray 21 and a button that allows the operator to give an instruction as to whether to continue or interrupt the execution of the job scheduled to be restarted are displayed on the dialogue screen D1 or D2. Note that, in the case of determining that the sheet types do not match each other in the sheet type matching determination after the restart of the job, the job execution determiner 432 discharges the sheet Sh to be used in the job after the restart, whose sheet type has been determined not to match that used in the job before the interruption, to the sub tray 53 different from the sheet discharge tray 51 to which the sheet Sh is scheduled to be output.

An explanatory diagram (1) of FIG. 14 illustrates a display example of the dialogue screen D1. The dialogue screen D1 is a screen that prompts, in a case where it is determined that the sheet types do not match each other in the sheet type matching determination after the restart of the job, the operator to check the sheets Sh in the sheet feed tray 21 (for example, a sheet feed tray 3) that stores the sheet Sh whose sheet type has been determined not to match that used in the job before the interruption. The operator who has checked the dialogue screen D1 checks the sheets Sh stored in the sheet feed tray 3. When determining that there is no problem in the sheet type of the sheets Sh stored in the sheet feed tray 3, the operator presses the continuation button. When the continuation button is pressed, the execution of the job is restarted as illustrated in step S55 in FIG. 13. On the other hand, when determining that there is a problem in the sheet type of the sheets Sh stored in the sheet feed tray 3, the operator presses the interruption button. When the interruption button is pressed, the job is deleted as illustrated in step S56 in FIG. 13.

An explanatory diagram (2) of FIG. 14 illustrates a display example of the dialogue screen D2. In the case of determining not to restart the execution of the job because it is determined that the sheet types do not match each other in the sheet type matching determination after the restart of the job, the job execution determiner 432 determines the presence or absence of another sheet feed tray 21 storing sheets Sh of the same sheet type (recording material information) as the sheet Sh supplied before the execution of the job is interrupted. In the case of determining the presence of the another sheet feed tray 21 storing the sheets Sh of the same type as the sheet Sh supplied before the execution of the job is interrupted, the job execution determiner 432 causes the operation display unit 13 to display a screen on which the operator can select whether to restart the execution of the job using the sheets Sh stored in the another sheet feed tray 21.

The dialogue screen D2 is a screen that prompts the operator to determine whether to restart the execution of the job using the sheets Sh stored in the another sheet feed tray 21. When the operator who has checked the dialogue screen D2 determines to perform sheet feeding from the another sheet feed tray 21 (described as “another tray” in FIG. 14) in which the sheets Sh of the same sheet type as the sheet type of the sheet Sh used before the interruption are set, the operator presses the continuation button. When the continuation button is pressed, a sheet Sh is fed from the another tray, and the execution of the job is restarted as illustrated in step S55 in FIG. 13. On the other hand, when determining not to perform the sheet feeding from the another tray, the operator presses the interruption button. When the interruption button is pressed, the job is deleted as illustrated in step S56 in FIG. 13.

In the image forming system 1 according to the embodiment described above, in a case where the job being executed is interrupted, the sheet type of the sheet Sh used in the interrupted job is stored in the sheet type storage 441. Thereafter, at the time of restarting the job, the medium sensor 41 detects the characteristic of the first sheet Sh fed from the sheet feeder 2, and the sheet type specifier 431 specifies the sheet type. The job execution determiner 432 then compares the sheet type of the sheet Sh used in the job before the interruption, which is read from the sheet type storage 441, with the sheet type of the sheet Sh specified at the time of restarting the job, and restarts the execution of the job if the sheet types are the same. As described above, it is confirmed that the sheet Sh is of the same sheet type as the sheet Sh used in the job before the interruption, and image formation on the sheet Sh to be used in the restarted job is favorably performed. Therefore, even in a case where the sheets Sh are replaced after the interruption of the job, the image formation on the sheet Sh is favorably performed at the time of restarting the job.

In addition, even in a case where sheets Sh are added to the sheet feed tray 21 after the interruption of the job, it is determined whether a sheet type of the added sheets Sh is appropriate at the time of restarting the job. If the sheet type is not appropriate, the restart of the job is stopped. Therefore, an image is not formed on a sheet Sh of a wrong sheet type, and an image defect on the sheet Sh can be eliminated.

The type of the characteristic of the sheet Sh detected by the medium sensor 41 may be one or more. Therefore, the sheet type specifier 431 can reliably specify the sheet type based on one or more types of the characteristic of the sheet Sh. Furthermore, the operator may select, through the operation display unit 13, the type of the characteristic of the sheet Sh detected by the medium sensor 41. Therefore, the sheet Sh having the characteristic emphasized by the operator in executing the job is used in the job.

In addition, even in a case where the execution of the job is not restarted, a condition for restarting the execution of the job is presented to the operator. For example, if sheets Sh of a sheet type different from the sheet type of the sheet Sh used in the job before the interruption are added to the sheet feed tray 21, the dialogue screen D1 is displayed to prompt the operator to check the sheets Sh stored in the sheet feed tray 21. Therefore, the operator can easily grasp a cause of preventing the restart of the execution of the job, and can take measures such as checking the sheets Sh added to the sheet feed tray 21. In addition, even if the sheets Sh used in the job before the interruption run out in the sheet feed tray 21, the dialogue screen D2 is displayed to prompt the operator to confirm whether a sheet Sh may be fed from the another sheet feed tray 21 storing the sheets Sh of the same sheet type as the sheet Sh used in the job before the interruption. Therefore, the operator can promptly instruct the image forming apparatus 3 to restart the execution of the job.

Although embodiments of the present invention have been described and illustrated in detail, the disclosed embodiments are made for purposes of illustration and example only and not limitation, and it goes without saying that various other application examples and modifications can be taken without departing from the gist of the present invention described in the claims. The scope of the present invention should be interpreted by terms of the appended claims.

For example, in the above-described embodiment, the engine controller 43 determines whether the sheet type, which is the recording material information, before the interruption of the job matches that after the interruption of the job, but may determine whether the characteristics of the sheets, which are the recording material information, match each other.

In addition, for example, the above-described embodiment describes the configuration of the system in detail and specifically in order to describe the present invention in an easy-to-understand manner, and is not necessarily limited to an embodiment having all the described configurations. Furthermore, it is also possible to add another configuration to the configuration of the present embodiment, and delete or replace a part of the configuration of the present embodiment.

In addition, control lines and information lines indicate what is considered to be necessary for the description, and do not necessarily indicate all the control lines and the information lines on the product. In practice, it may be considered that almost all the configurations are connected to each other.

What is claimed is:

1. An image forming system comprising:
an image forming apparatus including an image former that forms an image on a recording material based on a job;
a recording material supplier that supplies the recording material conveyed from a recording material storage that stores the recording material to the image former;
a characteristic detector that detects a characteristic of the recording material supplied from the recording material supplier; and
a hardware processor that determines, in a case where the job is interrupted, whether recording material information corresponding to a characteristic of a recording material before the interruption matches recording material information corresponding to a characteristic of a recording material after the interruption, and restarts execution of the interrupted job in a case where the recording material information corresponding to the characteristic of the recording material before the interruption matches the recording material information corresponding to the characteristic of the recording material after the interruption.

2. The image forming system according to claim 1, wherein
the hardware processor
specifies the recording material information based on the characteristic of the recording material detected by the characteristic detector,
determines to restart the execution of the interrupted job in a case where the recording material information used in the job before the interruption and specified by the hardware processor matches the recording material information specified by the hardware processor in association with the restart of the execution of the interrupted job, and
reads the recording material information used in the job before the interruption and specified by the hardware processor from a storage that stores the recording material information used in the job before the interruption and specified by the hardware processor.

3. The image forming system according to claim 2, wherein
the hardware processor determines to stop the execution of the interrupted job in a case where the recording material information read from the storage does not match the recording material information specified by the hardware processor in association with the restart of the execution of the interrupted job.

4. The image forming system according to claim 3, further comprising
a display that displays, when the hardware processor determines to stop the execution of the interrupted job, information indicating that processing of forming the image on the recording material has been stopped.

5. The image forming system according to claim 4, wherein
the hardware processor causes the storage to store the recording material information used in the job before the interruption when the hardware processor receives an instruction to interrupt the job in a middle of the execution of the job.

6. The image forming system according to claim 2, further comprising
a post-processor that performs post-processing on the recording material on which the image has been formed, wherein
the hardware processor determines, in a case where the post-processing is set for the job, whether to restart the execution of the job based on a grain direction and a rigidity of the recording material detected by the characteristic detector.

7. The image forming system according to claim 6, wherein
the post-processing includes at least one of an operation of folding the recording material, an operation of binding the recording material, an operation of perforating the recording material, an operation of gluing the recording material, or an operation of cutting the recording material.

8. The image forming system according to claim 6, further comprising
an inputter to which an instruction to execute or interrupt the job is input, wherein
the hardware processor interrupts the execution of the job in a case where the instruction to interrupt the job is input from the inputter or in a case where the recording material supplier detects that the recording material stored in the recording material storage has run out.

9. The image forming system according to claim 8, wherein
the characteristic detector detects the characteristic of the recording material based on an item to which a detection instruction is input through the inputter, and
the hardware processor determines whether the recording material information specified by the hardware processor based on the characteristic of the recording material detected by the characteristic detector matches the recording material information read from the storage.

10. The image forming system according to claim 2, wherein
the hardware processor restarts the execution of the job without making the matching determination on the recording material information in a case where the hardware processor determines that a state of the recording material storage that stores the recording material supplied before the execution of the job is interrupted does not change when it is determined to restart the execution of the job.

11. The image forming system according to claim 4, wherein
the hardware processor determines, in a case where it is determined not to restart the execution of the job, presence or absence of another recording material storage that stores a recording material having same recording material information as the recording material information of the recording material supplied before the execution of the job is interrupted.

12. The image forming system according to claim 11, wherein
in a case where the hardware processor determines the presence of the another recording material storage that stores the recording material having the same recording material information as the recording material information of the recording material supplied before the execution of the job is interrupted, the hardware processor causes the display to display a screen on which whether to restart the execution of the job using the recording material stored in the another recording material storage is selectable.

13. The image forming system according to claim 3, wherein
the hardware processor causes the characteristic detector to detect the characteristic of the recording material on which the image is not formed by the image former, specifies the recording material information, causes the image former to form the image on the recording material in a case where it is determined that the recording material information used before the interruption of the job matches the recording material information to be used after the restart of the job, and causes the recording material on which the image is not formed to be discharged in a case where it is determined that the recording material information used before the interruption of the job does not match the recording material information to be used after the restart of the job.

14. The image forming system according to claim 1, wherein
the characteristic detector detects, as the characteristic of the recording material, at least one of a surface property and a gloss of the recording material, a basis weight of the recording material, a moisture content of the recording material, or an electric resistance value of the recording material.

15. The image forming system according to claim 1, wherein
the characteristic detector detects, as the characteristic of the recording material, a grain direction and a rigidity of the recording material.

16. The image forming system according to claim 1, wherein
the recording material information is a type of the recording material.

17. The image forming system according to claim 14, wherein
the recording material is a sheet, and
the hardware processor specifies a type of the sheet as one of plain paper, high-quality paper, or coated paper based on the characteristic detected by the characteristic detector.

18. An image forming apparatus comprising:
an image former that forms an image on a recording material based on a job;
a recording material supplier that supplies the recording material conveyed from a recording material storage that stores the recording material to the image former;
a characteristic detector that detects a characteristic of the recording material supplied from the recording material supplier; and
a hardware processor that determines, in a case where the job is interrupted, whether recording material information corresponding to a characteristic of a recording material before the interruption matches recording material information corresponding to a characteristic of a recording material after the interruption, and restarts execution of the interrupted job in a case where the recording material information corresponding to the characteristic of the recording material before the interruption matches the recording material information corresponding to the characteristic of the recording material after the interruption.

19. A non-transitory recording medium storing a computer readable program causing a computer of an image forming apparatus including an image former that forms an image on a recording material based on a job to execute:
supplying the recording material conveyed from a recording material storage that stores the recording material to the image former;
detecting a characteristic of the supplied recording material; and
determining, in a case where the job is interrupted, whether recording material information corresponding to a characteristic of a recording material before the interruption matches recording material information corresponding to a characteristic of a recording material after the interruption, and restarting execution of the interrupted job in a case where the recording material information corresponding to the characteristic of the recording material before the interruption matches the recording material information corresponding to the characteristic of the recording material after the interruption.
